(19) United States
(12) Patent Application Publication
(10) Pub. No.: US 2011/0265110 A1
(43) Pub. Date: Oct. 27, 2011

(54) Audience Monitoring System Using Facial Recognition

(76) Inventor: Lee S. Weinblatt, Teaneck, NJ (US)

(21) Appl. No.: 13/093,547

(22) Filed: Apr. 25, 2011

Related U.S. Application Data
(60) Provisional application No. 61/327,398, filed on Apr. 23, 2010.

(51) Int. Cl. H04H 60/33

(52) U.S. Cl. 725/12

(57) ABSTRACT

A system for monitoring members of an audience watching a program broadcast by a programming signal source may include a audience monitoring unit positioned at a reception location with reproduction equipment to perform the broadcast program. The audience monitoring unit may include a camera, a facial recognition unit, and/or a component. The camera has a field of view of the reception location such that faces of the audience members at the reception location are within the field of view of the camera. The facial recognition unit is configured to recognize that faces of one or more persons are within the field of view of the camera and to determine if each of the one or more persons are watching the performance of the broadcast program. The component is configured to associate the broadcast program with the one or more recognized faces.

### CROSS-REFERENCE TO RELATED APPLICATIONS

This application claims priority to, and the benefit of, Provisional U.S. Patent Application No. 61/327,398, filed Apr. 23, 2010, the entirety of which is hereby incorporated herein by reference.

### FIELD OF THE INVENTION

Example embodiments relate to a system for providing audience monitoring information based on facial recognition of persons in the audience. In particular, the example embodiments are directed to an audience monitoring technique applied while an audience is listening and/or watching a program from a programming signal source as it is being performed by reproduction equipment and, for example, to a technique that monitors individual members of the audience based on facial recognition of the members of the audience.

### BACKGROUND OF THE INVENTION

It is desirable to obtain information about the audience watching a program for a number of reasons. The “program” may be audio and/or video, commercial and/or non-commercial, and is obtained as a programming signal from a program signal source. The “broadcast” of the program may be over the airwaves, cable, satellite, Internet, or any other signal transmission medium. The term “broadcast” applies to playback from recording media, e.g., audio tape, video tape, DAT, CD-ROM, and/or semiconductor memory or a live broadcast of a program. An “audience” for such program reproduction includes the persons who perceive the program, such as watching the video and/or listening to the audio. Accordingly, all the people who have perceived any part of the program are included in the audience.

The program is “performed” by any means which result in some form of perception by human beings, the most common being video and audio. The “reproduction equipment” is any and all types of units configured to convert a signal into human perceptible form.

Audience survey information has been obtained in the past by audience measurement and market research organizations for advertisers and broadcasters. For example, advertisers are interested in knowing the number of people exposed to their commercials. Broadcasters use statistics on audience size and type for setting their advertising rates.

An audience may be surveyed not only in terms of the number of persons in the audience but also to obtain characteristics of the individual members of the audience. For example, advertisers wish to identify the audience members by economic and social categories. This is possible if individual members of the audience can be identified.

Conventional automated audience surveying techniques are known in which test participants forming the audience in a monitoring arrangement need only play a passive role. For example, it is known to utilize a survey signal transmitted by a broadcast station in combination with a programming signal. The survey signal can include a code that identifies a particular program and/or broadcast station, for example. As disclosed in U.S. Pat. No. 4,718,106 (which is incorporated herein by reference in its entirety) issued to the present inventor, the transmitted survey signal is detected by a receiver and reproduced by a speaker. The speaker produces pressure waves in the air that can be detected by a microphone, and with a frequency that is in what is scientifically regarded as the audible range of human hearing. Such pressure waves, or signals, are referred to as acoustic. An acoustic signal is regarded herein as being audible, irrespective of whether the acoustic signal is actually heard by a person, as long as the acoustic signal is produced by a conventional speaker and detected by a conventional microphone. The audible acoustic signal is detected by a microphone and processed by associated circuitry embodied in a portable device worn by the test participants. Data on the incidence of occurrence and/or the time of occurrence of the acoustic signal, and the code the acoustic signal contains, are stored and analyzed to produce test results of the monitoring arrangement.

Variations of this passive technique can be found, for example, in U.S. Pat. Nos. 5,457,807 and 5,630,203 both issued to the present inventor (which are incorporated herein by reference in their entirety).

With the passive technique of the conventional art, each portable device can be pre-programmed with the unique identification (“ID”) of its wearer. This ID information is downloaded to a central processing station with the detected codes stored in the portable device to provide not only audience measurement data but also information about the individual audience members.

Although such a portable-device-based approach has great potential, it has several possible shortcomings even when implemented with the latest integrated circuit technology. For example, the cost per portable unit may be unacceptably high. Also, the devices may be too bulky to be worn comfortably. Furthermore, such devices require a high capacity memory to store all the information needed to provide the desired survey information. Lastly, the battery life is inconveniently shortened by all the functions such a device would need to perform. Accordingly, until better technology exists to implement such devices without these shortcomings, another approach may be preferable.

U.S. Pat. No. 7,155,159 (which is incorporated herein by reference in its entirety) issued to the present inventor discloses an audience surveying technique for identifying individual members of an audience listening to and/or watching a program performed from a programming signal source. A stationary apparatus is arranged at a reception location and is adapted to operate cooperatively with a simplified version of the portable devices designed to be worn by the audience members. The stationary apparatus detects and stores a surveying code transmitted with the program, and the stationary apparatus periodically emits a trigger signal which causes the portable devices to respond by emitting a unique identification signal pre-stored in each of the portable devices and which identifies its wearer. The stationary apparatus detects and stores the identification signals. Thus, the primary function of the simplified portable devices is to emit an identification signal. By associating the detected surveying code with the detected identification signals faster, more accurate, and more reliable identification of individual audience members tuned to a particular program is possible.

However, such a technique still requires that a portable device be worn by audience members. Further, such a technique cannot detect whether an audience member is actually “watching” the broadcast program, or if the audience member or the portable device of the audience member is merely present at the reception location while, for example, sleeping or reading.

### SUMMARY OF THE INVENTION

According to an example embodiment, an apparatus for monitoring members of an audience watching a program broadcast by a programming signal source comprises a audience monitoring unit positioned at a reception location with reproduction equipment to perform the broadcast program. The audience monitoring unit includes a camera, a facial recognition unit, and/or a component. The camera has a field of view of the reception location such that faces of the audience members at the reception location are within the field of view of the camera. The facial recognition unit is configured to recognize that faces of one or more persons are within the field of view of the camera and to determine if each of the one or more persons are watching the performance of the broadcast program. The component is configured to associate the broadcast program with the one or more recognized faces.

According to another example embodiment, a method for identifying members of an audience watching a program broadcast by a programming signal source comprises performing, at reproduction equipment positioned at a reception location with a audience monitoring unit, the broadcast program. The audience monitoring unit includes a camera having a field of view of the reception location such that faces of the audience members at the reception location are within the field of view of the camera. At a facial recognition unit in the audience monitoring unit, faces of one or more persons within the field of view of the camera are recognized. At the facial recognition unit, a determination is made as to whether each of the one or more persons are watching the performance of the broadcast program. The broadcast program is associated with the one or more recognized faces at a component in the audience monitoring unit.

### BRIEF DESCRIPTION OF THE DRAWINGS

The above and/or other aspects and advantages will become more apparent and more readily appreciated from the following detailed description of example embodiments taken in conjunction with the accompanying drawings of which:

FIG. 1 is a schematic block diagram of a system according to an example embodiment;

FIG. 2 shows details of the audience monitoring unit (“stationary unit”);

FIG. 3 is a flow chart showing operations performed by the system; and

FIG. 4 is a flow chart showing operations performed by the stationary unit.

### DETAILED DESCRIPTION OF THE DRAWINGS

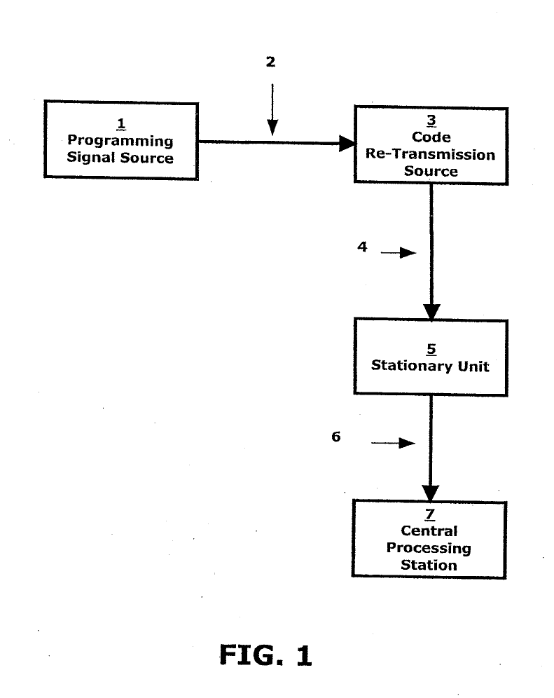

As shown in FIG. 1, an encoded signal is generated by a programming signal source 1, e.g., a TV broadcast station. The programming signal source 1 outputs the encoded signal as an output signal 2, which is a combination of a programming signal and a surveying code. The output signal 2 is received by code retransmission source 3. Code retransmission source 3 is configured to reproduce the programming signal for video and/or audio performance. For audience surveying purposes, the code retransmission source 3 is configured to detect the surveying code in the output signal 2 and to retransmit the surveying code as output signal 4. The output signal 4 is detected and processed by an audience monitoring unit (“stationary unit”) 5. Stationary unit 5 may transmit data via communications link 6 to a central processing station 7.

A discussion of the source 1 of the encoded program signal can be found in the above-mentioned patents of the present inventor, and such discussion found therein is incorporated herein by reference (along with the patents in their entirety).

Details of code retransmission source 3 can also be found in the above-mentioned patents issued to the present inventor, and such details found therein are incorporated herein by reference (along with the patents in their entirety). For example, the code retransmission source 3 may be a conventional component of a commercially available video and/or audio instrument, e.g., a television set or a computer with web browsing capability. The conventional component of interest may be, for example, the TV's speaker. No retrofitting of the instrument need be required in order for such component to function as a code retransmission source. For example, the output of code retransmission source 3 to stationary unit 5 may be in the form of an acoustic signal. See U.S. Pat. No. 4,718,106. However, according to another example embodiment some relatively minimal circuitry could be added to process and retransmit the code, as discussed in the above-mentioned patents of the present inventor. See U.S. Pat. Nos. 5,457,807 and 5,630,203.

The reception location that stationary unit 5 may be placed within is an area containing apparatus for reproducing the video and/or audio programming signal. The area may be of sufficient size to accommodate an audience, e.g., an audience of several members. For example, the reception location may be a room with a television set and seating capacity for accommodating several persons. Stationary unit 5 may be a self-contained, relatively small and unobtrusive unit that is placed on a surface in the room in such a way that a camera in the stationary unit 5 has a field of view of the reception location such that faces of the audience members at the reception location are within the field of view of the camera. Placement of the stationary unit 5 within the reception location may depend on the field of view of the camera and the seated location of the audience members at the reception location. The stationary unit 5 may be plugged into a wall outlet to receive power or it may be battery powered. The stationary unit 5 may have a wired or wireless connection to the Internet to enable data download. As such, a one time, relatively fast and simple installation is involved that need require no retrofit of another apparatus in the house.

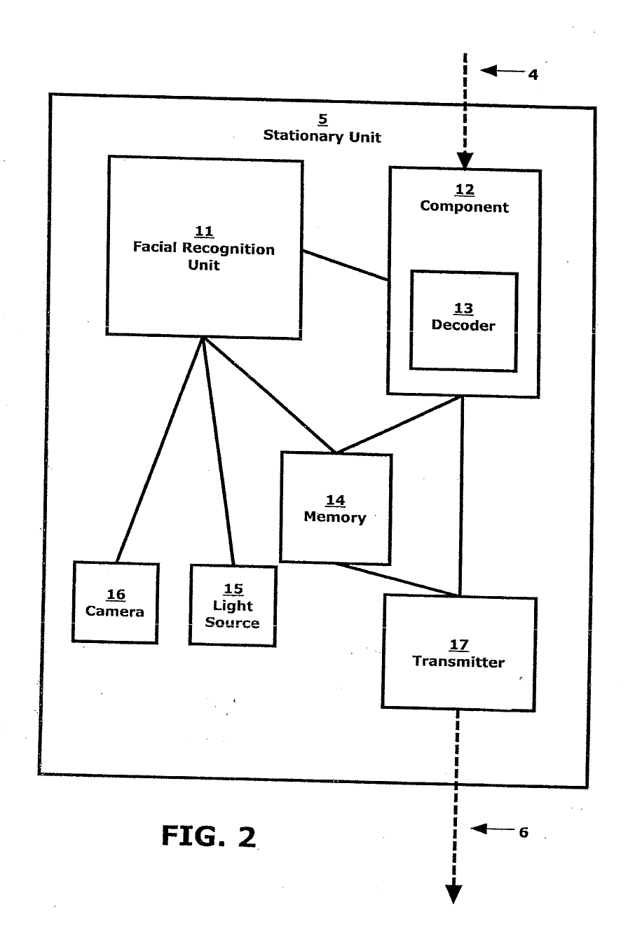

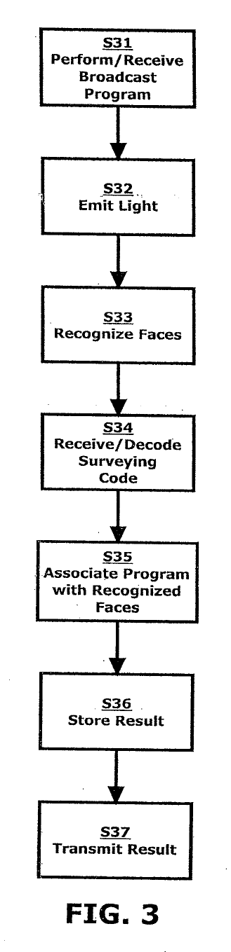

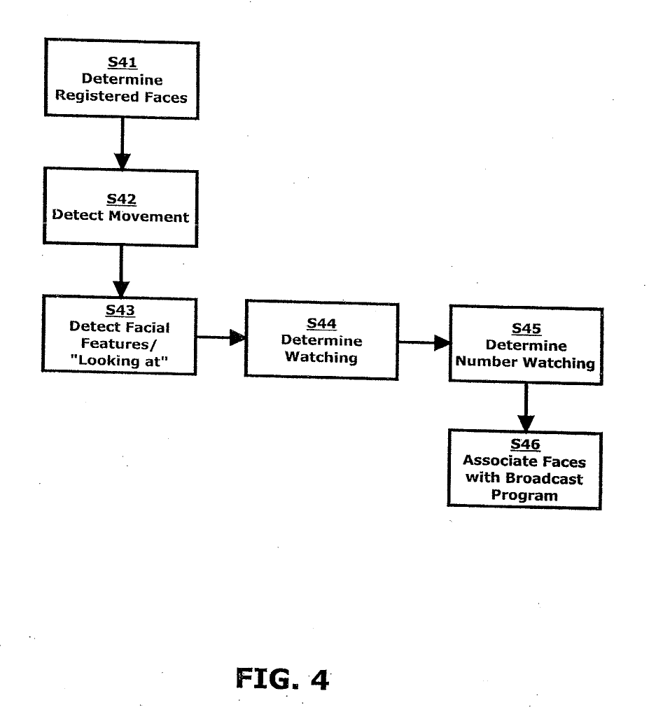

Details of stationary unit 5 will now be discussed in association with the schematic drawings of FIG. 2, and the flow charts of FIGS. 3 and 4. FIG. 2 depicts the hardware features including the stationary unit 5, while FIGS. 3-4 illustrate operations performed by the system and the stationary unit 5. The operations shown in FIGS. 3 and 4 may be implemented, for example, by a suitable microprocessor receiving input signals and generating control signals responsive thereto. The depictions in FIGS. 2-4 are illustrative, and specific implementations will be readily apparent to anyone with ordinary skill in the art.

The stationary unit 5 includes a facial recognition unit 11, a component 12 including a decoder 13, at least one memory 14, a light source 15, a camera 16, and/or a transmitter 17.

The code retransmission source 3 may be reproduction equipment performing the program broadcast by the programming signal source 1, and the reproduction equipment 3 may detect the surveying code transmitted with the broadcast program and retransmit the surveying code as the output signal 4 to the stationary unit 5 at step S31. The surveying code may be transmitted by the programming signal source 1 with a time stamp. Alternatively, receipt of the surveying code may be time stamped in the component 12. The time stamp for the surveying code may correspond to a broadcast time of a portion of the broadcast program.

The light source 15 is configured to emit a light at the reception location at step S32, e.g., to emit a light within a field of view of the camera 16. The light source 15 may be an infra red light source configured to emit an infra red light at the reception location.

The camera 16 is arranged at the reception location in such a way that faces of the audience members seated at the reception location are within the field of view of the camera. For example, the camera 16 may be positioned at the reception location above and/or behind a TV or other reproduction equipment 3 such that persons viewing or listening to a program performed by the reproduction equipment 3 are within the field of view of the camera 16. The camera 16 is a camera configured to capture still or moving/video images. The camera may be an infra red camera configured to capture still or moving/video infra red images. According to another example embodiment, the camera is part of a retina detection system configured to capture images of retinas of audience members, e.g., during lower light condition. Of course, the field of view for the camera 16 is selected to match the particular reception location.

The camera 16 may also be a plurality of cameras arranged at the reception location in such a way that faces of different portions of the audience members seated at the reception location are within the field of view of one or more of the plurality of cameras. Accordingly, if the reception location is too large for a single camera's field of view or if there are obstructions in the single camera's field of view, the faces of the entire audience at the reception location can still be within the collective field of view of the plurality of cameras. In an example embodiment that employs a plurality of cameras, the facial recognition unit 11 is configured to collect the captured images from each of the plurality of cameras, determine/discard duplicate faces, and/or perform the detection/determination of facial features described below in steps S43 and S44 based on images captured from a plurality of angles by one or more different cameras.

The facial recognition unit 11 is configured to recognize that faces of one or more persons are within the field of view of the camera 16 and to determine if each of the one or more persons are watching the performance of the broadcast program at step S33. For example, the facial recognition unit 11 may use processing, e.g., the known program OpenCV, on the images captured by the camera 16 to recognize the faces. The camera 16 captures the still or moving/video images and transmits the images to the facial recognition unit 11. The camera 16 or the facial recognition unit 11 may give the captured images a time stamp corresponding to a capture time of the images. Alternatively, the camera 16 may capture the images in response to the surveying code being received from the reproduction equipment 3. The captured images may be given a time stamp corresponding to the time stamp of the received surveying code or, if the surveying code does not include a time stamp, associated with the surveying code received at the same time as the captured images. The stationary unit 5, e.g., the camera 16, the facial recognition unit 11 and/or the component 12 in the stationary unit 5, can use a clock to associate the surveying code with images having a capture time the same as that of the receipt time of the surveying code. The facial recognition unit 11 performs the facial recognition at step S33 based on the images captured by the camera 16. For example, the facial recognition unit 11 processes/analyzes the images captured by the camera 16 using facial recognition software to recognize, i.e., identify and/or extract, faces in the images. Information extracted from the images including the one or more faces recognized by the facial recognition unit 11 and/or a corresponding time stamp for the recognized faces may be saved in the memory 14. The processing of the captured images and the recognized faces at the stationary unit 5 will be described in more detail below with respect to FIG. 4.

At step S34, the component 12 receives and decodes the surveying code retransmitted in the output signal 4 by the reproduction equipment 3. The decoder 13 included in the component 12 is configured to decode the surveying code. The component 12 may transmit the time stamp for the surveying code to the facial recognition unit 11. The surveying code and any time stamp for the surveying code may be saved in the memory 14.

Although step S34 is described as following step S33, example embodiments are not limited thereto and the order of steps S33 and S34 may be reversed.

The component 12 is configured to associate the broadcast program with the one or more faces recognized by the facial recognition unit 11 at step S35. For example, the recognized faces/persons recognized by the facial recognition unit 11 may be associated with the surveying code corresponding to the broadcast program. The component 12 may store a result of the association in the memory 14 at step S36. The association of the broadcast program with the one or more recognized faces at the stationary unit 5 will be described in more detail below with respect to FIG. 4.

The transmitter 17 is configured to transmit the result of the association to the central processing station 7 via communications link 6 at step S37. Communications link 6 may be any wired or wireless communications link, e.g., a LAN line, a cellular communications link, etc. For example, the transmitter 17 may be a mobile terminal wirelessly connected to a base transceiver station in a wireless telecommunications network. The transmitter 17 transmits the result of the association at desired, or alternatively, predetermined intervals or in response to a command from a user or the component 12.

FIG. 4 shows the operations performed by the stationary unit 5 in more detail. After recognizing the one or more faces in the captured images, the facial recognition unit 11 performs steps S41 through S45 of FIG. 4 based on the images captured by the camera 16 and the faces recognized in the captured images. At step S41, the facial recognition unit 11 determines if each of the recognized faces are registered faces. For example, the facial recognition unit 11 is configured to compare the one or more recognized faces to faces of registered persons stored in the memory 14 to determine if the persons are registered persons. The facial recognition unit may use processing, e.g., the known program Verilook, to determine if the persons are registered persons. Accordingly, the facial recognition unit 11 may determine if the persons watching the broadcast program are registered persons for which the audience monitoring system is interested in collecting information. Identification information on the registered persons may be stored in the memory 14, and corresponding identification information may be associated with each of the recognized faces/persons that are determined as registered. The identification information on the registered persons may include personal information, e.g., age, gender, etc., and/or program viewing history of the person. Alternatively, the identification information on the registered persons may be stored in the central processing station 7 and associated with the registered faces/persons outside of the stationary unit 5. If a recognized face is not a registered face, the facial recognition unit 11 may forgo the operations of steps S42 through S46 for the unregistered face/person. If the recognized face is a registered face, the operations of steps S42 through S46 may be performed for each of the recognized faces/persons.

Alternatively, even if a recognized face is not a registered face, the stationary unit 5 may still track the unregistered person. A first time that a face is recognized by the facial recognition unit 11 and is determined to not belong to a registered person, the facial recognition unit 11 may assign an anonymous identification number to the unregistered face/person and store the anonymous identification number in association with the data on the recognized face in the memory 14. The facial recognition unit 11 may then perform the operations of steps S42 through S46 for the recognized face associated with the anonymous identification number. The stationary unit 5 may alternatively provide an option for the unregistered person at the viewing location to register himself by inputting identification information into the stationary unit 5, e.g., by a keypad, in response to a prompt indicating that this particular audience member is not registered, e.g., by showing the face of the unregistered person on the broadcast equipment or a screen included in the stationary unit 5. The stationary unit 5 can then store the identification information on the newly registered person with the data on that person's face in the memory 14 and/or update the central processing station as to the registration of the new person.

The facial recognition unit 11 is configured to detect an amount of movement of each of the one or more recognized faces over a period of time and to determine if the amount of movement over the period of time for the recognized face meets a movement threshold at step S42. Accordingly, if the amount of movement for the recognized face meets the movement threshold the recognized face may be determined to belong to a “real” person, and not a picture located at the reception location. If the amount of movement of a recognized face does not meet the movement threshold, the facial recognition unit 11 may forgo the operations of steps S41 and S43 through S46.

The facial recognition unit 11 is configured to detect a status of at least one facial feature of each of the one or more recognized faces at a particular instance or over a period of time at step S43. The facial recognition unit 11 may detect whether one or both eyes of the face are open or closed, an angle of the face with respect to the camera or program broadcast, whether the person is “looking at” the camera or the broadcast program, and/or any other facial posture or movement of the recognized faces. The facial recognition unit 11 uses facial recognition software to process/analyze the captured images to detect the status of the facial features, e.g., the known program Faceit may be used to detect the status of the facial features. The facial recognition unit 11 may detect measurements for the facial features of the one or more recognized faces at one or more particular instances in time or the measurements for the features may be detected over a period of time, e.g., an average measurement for a feature may be determined over the period of time.

At step S44, the facial recognition unit 11 determines if the person is watching the performance of the broadcast program at the particular instance or over the period of time based on at least one of the facial features detected at step S43. A combination of the features detected in step S43 may be used to perform an overall determination in step S44 of whether the person is watching the performance of the broadcast program. For example, the facial recognition unit 11 may use the measurements of the angle of a face, if the eyes of the face are open or closed, and/or if the face of the person is “looking at” the camera or at the broadcast program to determine if the person is watching the broadcast program. For example, the facial recognition unit may determine that a person who is not “looking at” the camera or whose eyes are closed is not watching the broadcast program. Alternatively, a person whose eyes are open and who is “looking at” the camera may be determined to be watching the broadcast program.

The facial recognition unit 11 is configured to determine a number of persons watching the performance of the broadcast program at a particular instance or over a period of time at step S45. For example, the facial recognition unit 11 may determine the number of persons watching the performance of the broadcast program based on the time stamps of the recognized faces which are determined to be watching the broadcast program or based on the time at which the recognized faces which are determined to be watching the broadcast program were captured by the camera 13. Therefore, a number of persons who are actually watching the broadcast program at a particular time or period of time may be determined as compared to the number of persons which are recognized by the facial recognition unit 11. Accordingly, example embodiments may determine how many persons are watching a specific commercial or program at a specific time during the commercial or program.

At step S46, the component 12 associates the broadcast program with the recognized faces. As described above, recognized faces which are determined to not belong to actual persons, which are determined to not belong to registered persons, or which are determined to not be watching the broadcast program need not be associated with the broadcast program. However, registered faces belonging to actual persons who are watching the broadcast program may be associated with the broadcast program. The component 12 may associate the recognized faces with the broadcast program or the portion of the broadcast program which is being performed when the recognized faces are captured by the camera 16. According to an example embodiment, a surveying code for the broadcast program or a portion of the broadcast program is associated with recognized faces. The recognized faces and the surveying code may be associated with each other based on their respective time stamps or respective capture/receipt times in the stationary unit 5. The identification information (or the anonymous identification number) for the person may be associated with the broadcast program or the portion of the broadcast program. Accordingly, example embodiments enable the association of a program segment, as identified from the surveying code, with the audience in attendance, as identified from the recognized faces.

Although steps S41 through S45 of FIG. 4 are described in the order as shown in FIG. 4, example embodiments are not limited to such an order and steps S41 through S46 may be performed in any desired, or alternatively, predetermined order.

Returning to FIG. 3, at step S36, the result of the association is stored in the memory 14. For example, the image or images of the recognized face, measurement information relating to the facial features of the face, the identification information and/or the associated surveying code may be stored in the memory 14. At step S37, the transmitter sends the result of the association to the central processing station 7.

Although example embodiments have been shown and described in this specification and figures, it would be appreciated by those skilled in the art that changes may be made to the illustrated and/or described example embodiments without departing from their principles and spirit.

What is claimed is:

1. An audience monitoring unit for monitoring members of an audience watching a program broadcast by a programming signal source, the audience monitoring unit being configured to be positioned at a reception location with reproduction equipment to perform the broadcast program, the audience monitoring unit comprising:
a camera for producing still or video images;
a facial recognition unit configured to perform recognition of faces of one or more persons within a field of view of the camera, based on images received from the camera, and to determine whether each of the one or more persons is watching the performance of the broadcast program;
a component configured to associate the broadcast program with the one or more persons based on the recognition performed by the facial recognition unit.

2. The audience monitoring unit of claim 1, wherein the facial recognition unit is configured to detect a status of at least one facial feature of each of the faces of the one or more persons at a particular instance or over a period of time to determine whether each of the one or more persons is watching the performance of the broadcast program at the particular instance or over the period of time.

3. The audience monitoring unit of claim 1, wherein the facial recognition unit is configured to detect an amount of movement of each of the faces of the one or more persons over a period of time and to determine whether the amount of movement over the period of time for each of the faces meets a movement threshold.

4. The audience monitoring unit of claim 1, wherein the facial recognition unit is configured to determine a number of persons watching the performance of the broadcast program at a particular instance or over a period of time.

5. The audience monitoring unit of claim 1, wherein the facial recognition unit is configured to compare the faces of the one or more persons to faces of registered persons stored in a memory to determine whether the one or more persons are registered persons.

6. The audience monitoring unit of claim 1, wherein
the reproduction equipment is configured to receive and retransmit a surveying code transmitted in combination with the program broadcast by the programming signal source, and
the component includes a decoder configured to receive and decode the retransmitted surveying code, the component associating the surveying code for a particular time with the faces of the one or more persons recognized at the particular time to indicate that each of the one or more persons is watching the performance of the broadcast program at the particular time.

7. The audience monitoring unit of claim 6, wherein the facial recognition unit is configured to perform recognition of the faces of the one or more persons within the field of view of the camera in response to the decoder receiving the surveying code, the particular time being a time at which the surveying code is received at the decoder.

8. The audience monitoring unit of claim 6, wherein the surveying code is transmitted by the programming signal source with a time stamp indicating the particular time.

9. The audience monitoring unit of claim 1, wherein the facial recognition unit further includes an infra red light source, the camera is an infra red camera, and the facial recognition unit is configured to perform recognition of the faces of the one or more persons based on infra red images captured by the infra red camera.

10. The audience monitoring unit of claim 1, wherein the audience monitoring unit further includes a transmitter configured to transmit a result of the association of the broadcast program with the one or more persons to a central processing station.

11. A method for monitoring members of an audience watching a program broadcast by a programming signal source, comprising:
performing, at reproduction equipment positioned at a reception location with an audience monitoring unit, the broadcast program, the audience monitoring unit including a camera for producing still or video images,
performing recognition, at a facial recognition unit in the audience monitoring unit, of faces of one or more persons within a field of view of the camera based on images received from the camera;
determining, at the facial recognition unit, whether each of the one or more persons is watching the performance of the broadcast program; and
associating, at a component in the audience monitoring unit, the broadcast program with the one or more persons.

12. The method of claim 11, further comprising:
detecting, at the facial recognition unit, a status of one or more facial features of each of the faces of the one or more persons at a particular instance or over a period of time to determine whether each of the one or more persons is watching the performance of the broadcast program at the particular instance or over the period of time.

13. The method of claim 1, further comprising:
detecting, at the facial recognition unit, an amount of movement of each of the faces of the one or more persons over a period of time and determining whether the amount of movement over the period of time for each of the faces meets a movement threshold.

14. The method of claim 1, further comprising:
determining, at the facial recognition unit, a number of persons watching the performance of the broadcast program at a particular instance or over a period of time.

15. The method of claim 1, further comprising:
comparing, at the facial recognition unit, the faces of the one or more persons to faces of registered persons stored in a memory to determine whether the one or more persons are registered persons.

16. The method of claim 1, further comprising:
receiving, at the reproduction equipment, a surveying code transmitted in combination with the program broadcast by the programming signal source and retransmitting the surveying code;
receiving, at a decoder included in the component, the retransmitted surveying code and decoding the retransmitted surveying code; and
associating, at the component, the surveying code for a particular time with the faces of the one or more persons recognized at the particular time to indicate that each of the one or more persons is watching the performance of the broadcast program at the particular time.

17. The method of claim 6, wherein the recognition, at the facial recognition unit, is performed in response to the decoder receiving the surveying code, the particular time being a time at which the surveying code is received at the decoder.

18. The method of claim of claim 6, wherein the surveying code is transmitted by the programming signal source with a time stamp indicating the particular time.

19. The method of claim 1, further comprising:
emitting an infra red light, using an infra red light source, wherein the camera is an infra red camera, and the recognition, at the facial recognition unit, of the faces of the one or more persons is performed based on infra red images captured by the infra red camera.

20. The method of claim 1, further comprising:
transmitting, from a transmitter in the audience monitoring unit, a result of the association of the broadcast program with one or more persons to a central processing station.
